(19) United States
(12) Patent Application Publication
(10) Pub. No.: US 2005/0131915 A1
(43) Pub. Date: Jun. 16, 2005

(54) Concept directory

(76) Inventors: Jaye D. Hicks, Frisco, TX (US); Randall F. Mears, Plano, TX (US); Curtis W. Patrick, Frisco, TX (US)

Correspondence Address: STEPHEN R. LOE, THE LAW OFFICE OF STEPHEN R. LOE, P.O. BOX 649, FRISCOE, TX, 75034, US

(21) Appl. No.: 10/736,143

(22) Filed: Dec. 15, 2003

(51) Int. Cl. G06F 17/00

(52) U.S. Cl. 707/100

(57) ABSTRACT

A centralized repository of enterprise defined basic enterprise concept data and a method, system, and computer program product for accessing and manipulating that data is provided. In one embodiment the system includes a directory of enterprise defined basic enterprise data, a consumer user interface to provide access to the directory; a real-time interface to provide access to data stored in other systems and a data manager interface to provide an interface for managers of basic enterprise data to update and add data to the directory. The directory provides a centralized location for all users and applications utilized within an enterprise to locate and access enterprise defined basic enterprise data thereby facilitating the exchange of expertise across the enterprise and standardizing terminology across the enterprise. The system incorporates security features to prevent unauthorized access to and modification of data within the directory as well as search and reporting features allowing a user or an application to search the directory for desired data as well as to receive notices, for example, when data or interest to the user or application has been modified.

### BACKGROUND OF THE INVENTION

1. Technical Field

The present invention relates generally to computer software and, more particularly, to an improvement.

2. Description of Related Art

Modern corporations and other enterprises rely on data processing systems to perform or aid in performance of many or most of the activities performed by the corporation enterprise. This is even more true of large enterprises that employ thousands of people. The larger the enterprise, the more disparate groups there are within the organization. For example, a single corporation may have divisions that develop computer software, that develop computer hardware, that provides information technology services, that manufactures consumer electronics, and perhaps provide financial services. Each division may also incorporate its own sales and marketing force as well as accounting functions.

Despite the differences between the groups, there may be areas of possible commonality and sharing of information. For example, many of the different areas may deal with the same vendors and use the same software products. However, currently, enterprises with multiple divisions and groups maintain a multitude of internal applications that maintain redundant information. This is an inefficient use of storage resources, which results in a decrease in profits for a corporation because of the money expended on increased storage capacity to store redundant data. Furthermore, there is no current mechanism allowing the different areas within an enterprise to share information, because, even if it were possible to somehow execute a search across all of these applications, the results would be inconsistent and hard to decipher because no standard terminology is enforced across each of these systems. For example, a search for the string of “mobility” might bring back unexpected results because of the varied opinion within an enterprise as to exactly what “mobility” is. Some would argue that the correct word to use would be “wireless communication” rather than mobility.

Therefore, to decrease redundancy in information storage and increase communication between areas of a large enterprise, it would be desirable to have a system that provides central storage of basic enterprise information that enforces standard terminology across an enterprise, thereby assisting in the location of expertise within the enterprise, assisting in impact analysis activities, and helping to raise awareness of corporate-level standards, agreements, capabilities, and offerings.

### SUMMARY OF THE INVENTION

The present invention provides a centralized repository of enterprise defined basic enterprise concept data and a method, system, and computer program product for accessing and manipulating that data. In one embodiment the system includes a directory of enterprise defined basic enterprise data, a consumer user interface to provide access to the directory; and a data manager interface to provide an interface for managers of basic enterprise data to update and add data to the directory. The directory provides a centralized location for all users and applications utilized within an enterprise to locate and access enterprise defined basic enterprise data thereby facilitating the exchange of expertise across the enterprise and standardizing terminology across the enterprise. The system incorporates security features to prevent unauthorized access to and modification of data within the directory as well as search and reporting features allowing a user or an application to search the directory for desired data as the ability to receive notices, for example, when data or interest to the user or application has been modified.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server in accordance with the present invention;

FIG. 3 depicts a block diagram of a data processing system in which the present invention may be implemented;

FIG. 4 depicts a schematic diagram illustrating an exemplary concept directory, interfaces, an relationships to other areas within an enterprise in accordance with one embodiment of the present invention;

FIG. 5 depicts a diagram illustrating the flow and aggregation of separate, unique concepts or concept components from multiple disparate systems into a single concept which can be utilized, via the concept directory, by a user or application in accordance with one embodiment of the present invention; and

FIG. 6 depicts a table illustrating an example of potential attributes for a concept in accordance with one embodiment of the present invention.

### DETAILED DESCRIPTION OF THE PREFERRED EMBODIMENT

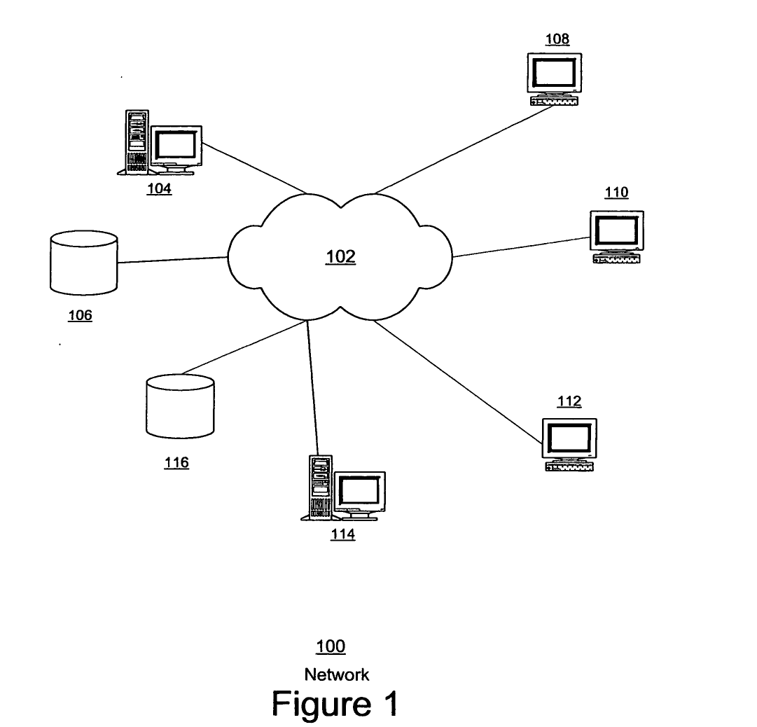

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. This server 104 and storage unit 106 provide the functionalizty and storage capacity for implementing the concept directory of the present invention. In addition to server 104 and storage unit 106, other servers 114 and storage units 116 may be connected to network 102. These other servers 114 and storage units 116 provide the raw data that is used and arranged by the concept directory to form concepts that may be provided to users and applications within the enterprise. Although storage units 106 and 116 are depicted as separate from servers 104 and 114, in some embodiments, the storage units 106 and 116 are incorporated within respective servers 104 and 114.

In addition, clients 108, 110 and 112 are also connected to network 102. These clients, 108, 110 and 112, may be, for example, personal computers or network computers. For purposes of this application, a network computer is any computer coupled to a network that receives a program or other application from another computer coupled to the network. Distributed data processing system 100 may include additional servers, clients, and other devices not shown. Clients 108, 110, and 112 may be utilized by users and applications to access the concept directory and obtain concepts of interest.

Storage unit 106 contains concepts and other data stored by the concept directory which provides a centralized, official, and definitive place of record for basic information required by numerous software applications and individual users within an enterprise. The information may include information about external companies (e.g., vendors, alliance partners, competitors, clients), standard spellings and addresses for these companies, and contact information. The information may also include commercially available products (e.g., Bluetooth) with lists of enterprise subject matter experts for a given product, a list of enterprise engagement with a given product, and a list of vendors for various products. Additionally, the information may include information about generic technology (e.g., wireless communication) and contain a list of enterprise subject matter experts for a given technology, a list of enterprise engagements with a given technology, and a list of vendors for various technologies. Other information stored in the concept directory may include enterprise portfolio information (i.e., standard capabilities and offerings), industry standards and standards committees, master agreements and corporate licenses, and enterprise organizational structure. The types of information stored in the concept directory may also include other information not listed above, as will be recognized by those skilled in the art.

Server 104 provides an interface and other mechanisms for implementing a concept directory and for allowing users and applications within the enterprise to retrieve and/or update information in the concept directory within storage 106. The concept directory may provide a user with data stored within the concept directory or may obtain raw data from other repositories 116 within the enterprise, arrange the raw data into concepts and provide the concepts to a user in real time. The concept directory may also provide the user with data obtained partly from data stored within the concept directory and partly obtained in real time from other repositories 116 within the enterprise. The interfaces provided by server 104 may include a web application interface and a web service interface allowing users and applications to access the information in the concept directory. The interfaces may also include a web application interface allowing a system administrator to perform normal monitoring and administrative duties on the concept directory. Finally, the interfaces may also include back-end integration, such as, a batch Application Programming Interface (API), a dynamic API, a web service interface, a web application interface, and Enterprise application Interface (EAI), or other custom API, allowing various users, applications, and groups within the enterprise to update the concept directory with information they have. The concept directory and its functioning is described in greater detail below.

In the depicted example, distributed data processing system 100 is a private internet, with network 102 representing an enterprise wide collection of networks and gateways that use the TCP/IP suite of protocols to communicate with one another. At the heart of the private Internet is a backbone of high-speed data communication lines between major nodes or host computers consisting of tens, hundreds, or thousands of computer systems that route data and messages. Of course, distributed data processing system 100 also may be implemented as a number of different types of networks such as, for example, a public Internet, an intranet, a local area network, or a wide area network.

FIG. 1 is intended as an example and not as an architectural limitation for the processes of the present invention.

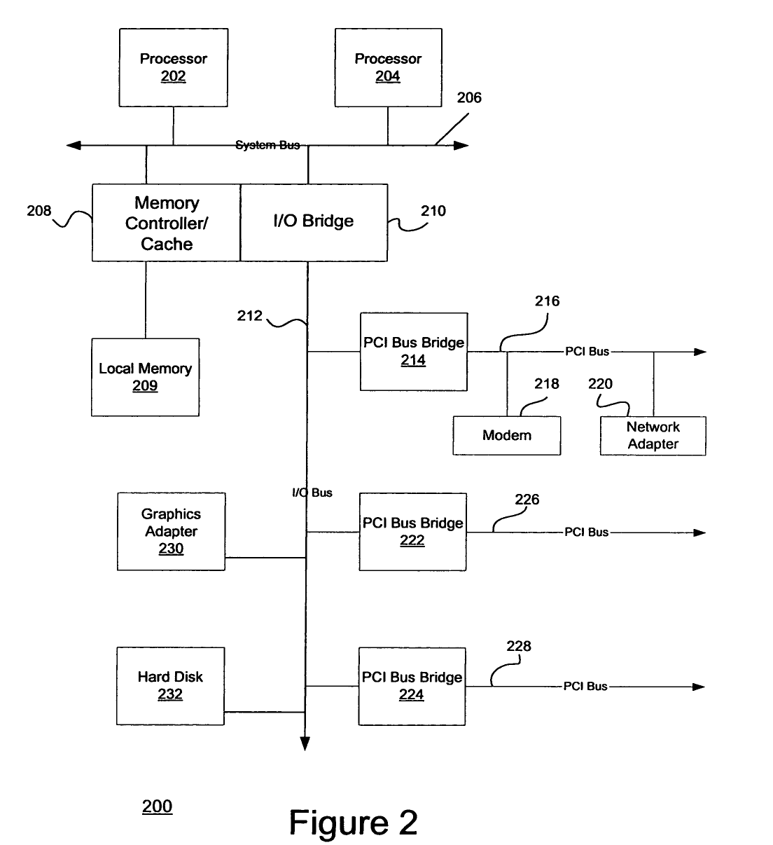

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Server 200 includes web application interfaces and web service interfaces allowing users to access a concept directory. Server 200 also includes a web application interface allowing a system administrator to perform normal monitoring and administrative duties on the concept directory as well as includes back-end integration allowing users, applications, and groups within the enterprise to update and add information to the concept directory. Server 200 may also maintain and enforce security settings on information elements contained in the content directory, thus allowing content owners to collaborate with one another during the development of unreleased content, but doing so undetected by the normal user base.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

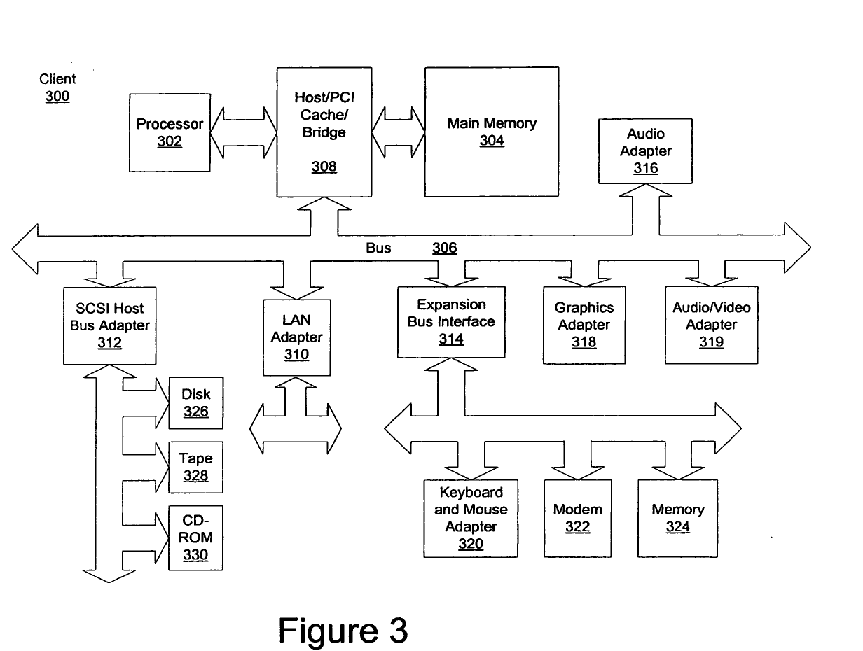

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302. In addition, a web browser may also run on top of the operating system, allowing users to access and search content contained within the concept directory.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

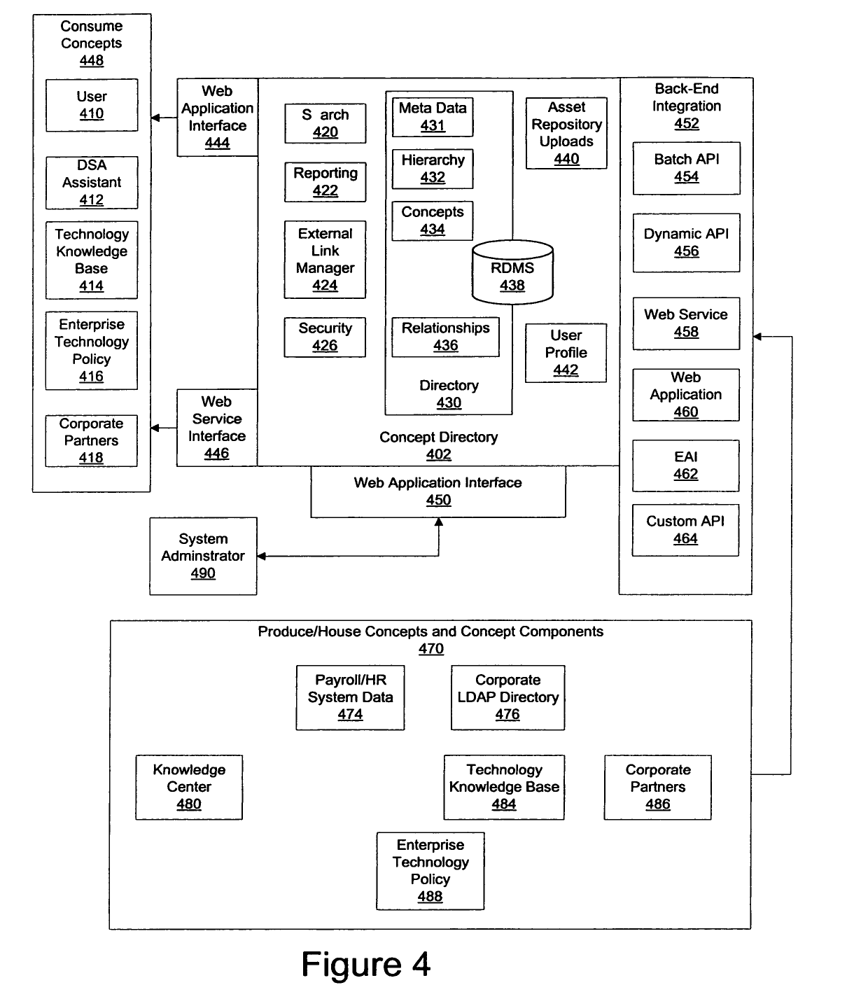

With reference now to FIG. 4, a schematic diagram illustrating an exemplary concept directory, interfaces, and relationships to other areas within an enterprise is depicted in accordance with one embodiment of the present invention. The concept directory 402 and related interfaces, 444, 446, 450 and back-end integration 452 may be implemented on, for example, server 104 and storage 106 depicted in FIG. 1. Although storage unit 106 is depicted as a separate unit from server 104, in some embodiments, storage unit 106 may be incorporated within server 104. Concept directory 402 includes, but is not limited to, information on items such as, for example, standard spellings and definitions for concepts such as:
External Companies (i.e. vendors, alliance partners, competitors, clients)
Commercially Available Products (e.g. Bluetooth)
   List of Enterprise Subject Matter Experts for a given product
   List of Enterprise Engagement with a given product
   List of vendors for various products
Generic Technology (e.g. wireless communications)
   List of Enterprise Subject Matter Experts for a given technology
   List of Enterprise Engagement with a given technology
   List of vendors for various technologies
Enterprise Portfolio Information (i.e. standard capabilities and offerings)
Industry Standards and Standards Committees
Master Agreements and Corporate Licenses
Enterprise Organizational Structure

Concepts 434 in the concept directory 402 are kept in a directory 430 that structures the concepts 434 in a hierarchal/tree fashion, organized from general concept (e.g. root of hierarchy) to specific concept (leaf node of hierarchy) by keeping a Hierarchy data 432 and relationships data 436. These various hierarchy 432, concepts 434, and relationships 436 are kept in a relational data base management system (RDMS) 438, thus allowing Boolean and wildcard searches to be performed on the data contained within the concept directory 402. Concepts in the hierarchy can have multiple “organizational parents” and may be arbitrarily interrelated to other concepts irrespective of their organizational hierarchical relationships.

Concept directory 402 includes a meta data unit 431 which contains meta data that is implementation dependent specific to an enterprise that includes, among other items, knowledge of what repositories of data exist within the enterprise, what kind of data reside on each of these other repositories, and how to combine the raw data from the various repositories into concepts. Concept directory 402 also includes an asset repository upload unit 440 allowing data and information stored in the directory 430 to be uploaded from other sites within an enterprise. The concept directory 402 also includes a search facility 420 allowing users to search for data in directory 430 or in other repositories of data within the enterprise. A reporting utility 422 creates reports, alerts, and notifications for events of interest to users as requested by users. These alerts could be, for example, an update of content that is of particular interest to a user. Concept directory 402 also includes a security utility 426 that enforces security policies for the enterprise, such as, for example, as regards access to and updates to data in the concept directory 402, thus preventing data from being inadvertently or maliciously changed and preventing access to certain data elements by certain users within the enterprise as desired by the enterprise. An external link manager 424 manages links to data residing elsewhere in the enterprise. Concept directory 402 includes a user profile unit 442 that manages user identities and user preferences. For example, user profile unit 442 may keep track of and aid reporting utility 422 in providing notices to a user that specific concepts identified by the user as important have been updated or have had data added.

The concept directory 402 also provides two primary interfaces and one system administrative interface. The first primary interface, in one embodiment, takes the form of a web application interface 444 and a web service interface 446. The web application interface 444, accessible through a standard web browser (no Active-X control or Web browser plug-in required), allows users to navigate structured content and to perform predefined or ad-hoc searches on the concept directory 402 content. Users are presented directory information that is structured in a hierarchal/tree fashion, organized from general concept (e.g. root of hierarchy) to specific concept (leaf node of hierarchy). Concepts in the hierarchy, as mentioned above, can have multiple “organizational parents” and may be arbitrarily interrelated to other concepts irrespective of their organizational hierarchical relationships. Powerful searches (e.g. Boolean, wildcard, etc.) can be performed against the content. Users can be assigned to security groups which can dictate their level of access to content. Information can be secured down to the detailed attribute level of a single concept. Users can interact with the information contained in the concept directory, collecting and arranging concepts in their own personal work space, as they see fit. This user-specific customization of the information is persistent across user login sessions. As mentioned above, users can also request alerts and notifications for events of interest, such as the update of content of particular interest to the user.

The web service interface 446 allows applications to programmatically search for and/or retrieve information from the concept directory. Using the web service interface 446 an application could maintain a concept directory ID, in place of separate unique, and redundant information. As necessary, this ID can be dereferenced to supply up-to-date, standard information. In some embodiments, these applications maintain the “last known good value” of a dereferenced concept ID along with the ID itself to safeguard against the eventuality that the concept directory 402 is temporarily unavailable.

Thus, web application interface 444 and web service interface 446 provide a mechanism for consumers of concepts 448, such as a user 410 or applications 412, 414, 416, and 418 to access and utilize information in the concept directory 402.

The second primary interface is the back-end integration 452 to the concept directory 402. The back-end integration may take many forms, such as, for example, a batch Application Programming Interface (API) 454, a dynamic API 456, a web service 458, a web application 460, an Enterprise application Interface (EAI) 462, or a custom API 464. However, the back-end integration 452 may take other forms as will be recognized by those skilled in the art. Through this back-end integration upload and maintenance interface 452, content owners (i.e., people responsible for concept directory content) can perform their normal duties by scheduled task or in real time. Each concept stored in the concept directory 402 may be associated with a particular content owner, enterprise group, or application and modification to the concept limited to the concept owner, group, or application. The enterprise may also organizationally assign various aspects of the concept management to different parties within the enterprise, with that party responsible for determining standard spellings, contact information, lists, etc. for concepts under their management, thereby ensuring standardization of concepts across the enterprise and also facilitating comprehensive impact analysis of corporate-level decisions regarding products, technologies, and external companies, such as vendors and alliance partners.

Data from various content repositories 474, 476, 480, 484, 486, and 488 may be sent to concept directory 402 for example, as a batch process implemented perhaps once a day, as updates or additions to data in the repositories 474, 476, 480, 484, 486, and 488 are made, or as requested by concept directory 402. Concept directory 402 collects the raw data from the various repositories 474, 476, 480, 484, 486, and 488 and organizes the data into concepts based on meta data contained in meta data unit 431.

By employing security settings on information elements contained in the content directory, as described above, content owners can collaborate with one another during the development of unreleased content, doing so undetected by the normal user base. Thus, producers of and repositories for concepts and concept components 470, such as repositories 474, 476, 480, 484, 486, and 488 may update and add information to the concept directory 402 as necessary. Repositories 474, 476, 480, 484, 486, and 488 are examples of typical enterprise repositories. However, the number and type of repositories may vary from enterprise to enterprise.

System administrators 490 can perform normal monitoring and administrative duties on the concept directory through a web application interface 450.

The components depicted in FIG. 4 are presented as examples of components that may be utilized in implementing the processes of the present invention. However, those skilled in the art will recognize that many modifications to this exemplary architecture may be made without departing from the scope and spirit of the present invention. For example, additional or different interfaces other than interfaces 444 and 446 may be utilized in providing access to concept directory by concept consumers 448. Other modifications will be obvious to those skilled in the art. Therefore, the present invention is not limited by the architecture depicted in FIG. 4, but is only defined by the appended claims.

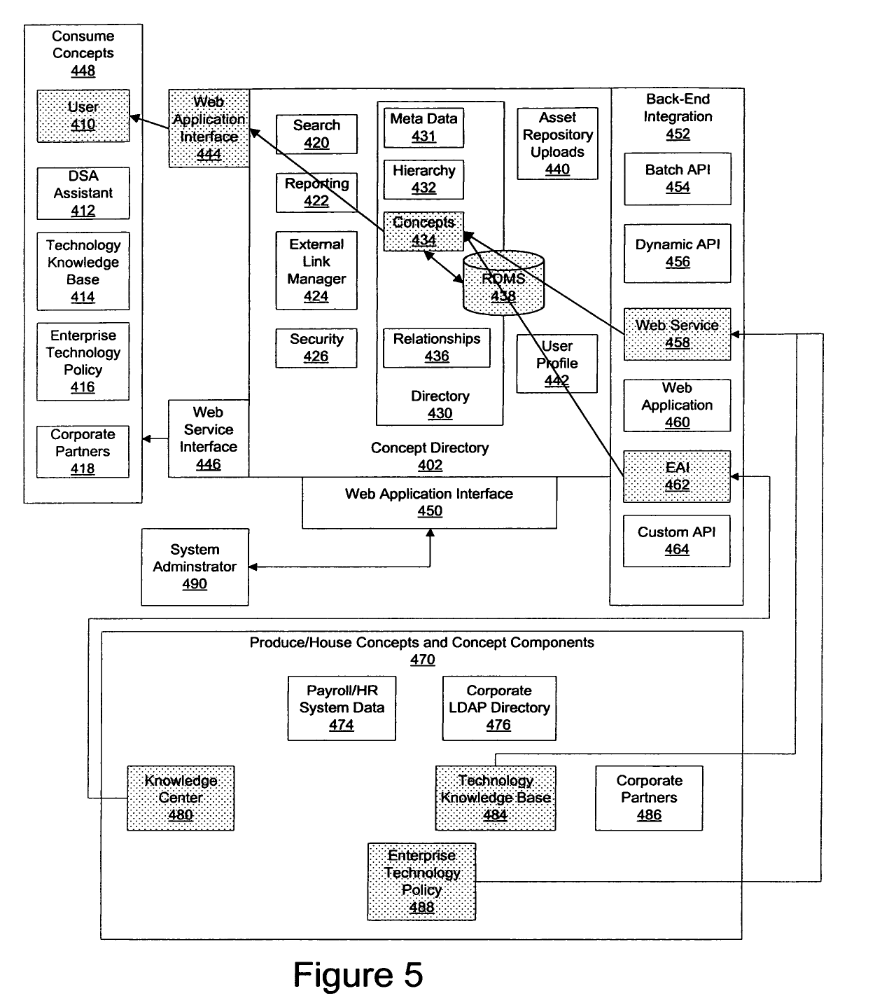

With reference now to FIG. 5, a diagram illustrating the flow and aggregation of separate, unique concepts or concept components from multiple disparate systems into a single concept which can be utilized, via the concept directory, by a user or application is depicted in accordance with one embodiment of the present invention. The shaded areas 410, 444, 434, 438, 458, 462, 480, 484, 488 depict an exemplary path by which individual concepts or components of concepts might take in order to become integrated and ultimately presented to the end user 410 of the concept directory 402. Each of the Technology Knowledge Base 484, Knowledge Center 480, and Enterprise Technology Policy 488, in the depicted example, sends data to the concept directory 402. The data sent to the concept directory 402 is then organized into concepts by the concept directory 402 based on meta data in meta data unit 431. Meta data unit 431 contains enterprise specific meta data with knowledge about what kind of data is kept by various repositories within the enterprise and how the data should be organized as concepts. The concepts include concept attributes, such as concept name, inception date, description, that allow clients (e.g., users and applications) to search for particular concepts. Data from various repositories is received through back-end integration 452. In the depicted example, Technology Knowledge Base 484 and Enterprise Technology Policy 488 interact with the concept directory 402 via web service interface 458 while Knowledge Center 480 interacts via EAI 462. The concepts are stored in the concepts 434 portion of RDMS 438 or on various other repositories within the enterprise and are related to one another via attributes using meta data from meta data unit 431 which contains data and rules specific to the enterprise about how to combine raw data into concepts. These concepts with attributes which may have been searched on by user 410 are then sent to user 410 via, for example, web application interface 444. The concepts may be obtained directly from RDMS 438, in real time from, for example, Knowledge Center 480, Technology Knowledge Base 484, and Enterprise Technology Policy 488, wherein the concept directory 402 prompts the various repositories 480, 484, and 488 for the appropriate data and organizes the data into concepts for presentation to user 410, or through a combination of concept data stored in RDMS 438 and obtained in real time from repositories 480, 484, and 488.

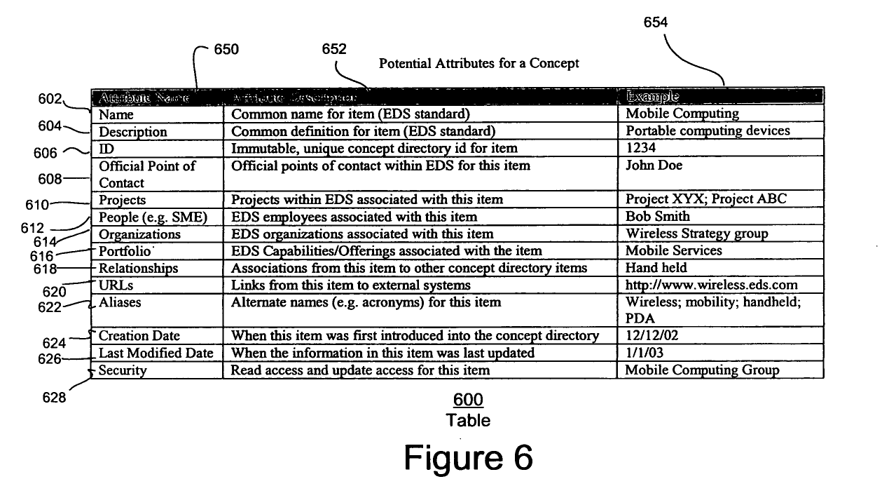

With reference now to FIG. 6, a table illustrating an example of potential attributes for a concept is depicted in accordance with one embodiment of the present invention. Table 600 includes a column for an attribute name 650, for an attribute description 652, and for an example of the attribute 654. In this embodiment, concept attributes include name 602, description 604, ID 606, Official Point of contact 608, Projects 610, People 612, Organizations 614, Portfolio 616, Relationships 618, URLs 620, Aliases 622, Creation Date 624, Last Modified Date 626, and Security 628.

The attributes, names, descriptions, and examples provided in table 600 are provided merely for illustration purposes only. Those skilled in the art will recognize that many other or different attributes may also be used depending on the requirements of the particular enterprise and implementation.

Although described as though all basic information to the enterprise is “officially” housed in the concept directory, clearly, in some embodiments, some of the information presented by the concept directory would be “officially” housed and maintained in a different system (e.g., organizational structured housed in CAS or SAP). In addition, some of the information presented by the concept directory would be derived from information that is integrated from a number of other sources, an example, of which is depicted in FIG. 5. Some information presented by the concept directory may be unique to and officially housed and maintained in the concept directory itself. However, the concept directory provides a central point for storage of and access to basic information that is used by multiple areas within an enterprise, thus mitigating the number of local, isolated, and redundant versions of information and standardizing the information across the enterprise.

Furthermore, with the concept directory, future applications of the enterprise can be designed, and existing applications can be retrofitted, to access information contained within the concept directory. This will obviate the need for new and existing applications to internally replicate certain information or to seek out and to integrate with a number of systems that contain the information. The concept directory will greatly reduce the complexity involved in creating/maintaining numerous internal systems and will greatly reduce the probability that creating a new system will mean the creation of yet another redundant island of data. Furthermore, consolidating concepts into a central concept directory will enforce a standard terminology/definition, assist in locating expertise within the enterprise, assist impact analysis activities, and help raise awareness of corporate-level standards/agreements/capabilities/offerings.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for providing enterprise wide access to and standardization of concepts utilized by diverse groups within an enterprise, the method comprising:
creating a centralized concept directory;
storing enterprise concepts and metadata in the concept directory; and
directing an enterprise software application, a specific concept is needed by the software application, to provide the specific concept to the software application.

2. The method as recited in claim 1, wherein the software application is a web browser retrieving information for a user.

3. The method as recited in claim 1, further comprising:
implementing enterprise security procedures to prevent unauthorized access to the concepts in the concept directory.

4. The method as recited in claim 1, further comprising:
assigning a user to a security group which dictates the level of access by the user to content within the concept directory.

5. The method as recited in claim 1, wherein the concepts are structured in a hierarchal fashion organized from a general concept to a specific concept.

6. The method as recited in claim 1, wherein the concepts are structured to contain relationship information relating each element of the concepts to various other related elements, thereby allowing searches on the concept directory to retrieve related elements.

7. The method as recited in claim 1, wherein the concepts comprise at least one of a external companies, commercially available products, generic technology, enterprise portfolio information, industry standards and standards committees, master agreements and corporate licenses, and enterprise organizational structure.

8. The method as recited in claim 7, wherein the external companies comprises at least one of vendors, alliance partners, competitors, and clients.

9. The method as recited in claim 7, wherein the commercially available products comprises at least one of a list of enterprise subject matter experts for a given product, a list of enterprise engagements with a given product, and a list of vendors for various products.

10. The method as recited in claim 7, wherein the generic technology comprises at least one of a list of enterprise subject matter experts for a given technology, a list of enterprise engagements with a given technology, and a list of vendors for various technologies.

11. The method as recited in claim 1, wherein the concepts comprise elements that have several attributes and the attributes comprise at least one of name, description, identification, official point of contact, project, people, organizations, portfolio, relationships, universal resource locators, aliases, creation date, last modified date, and security.

12. The method as recited in claim 1, further comprising:
determining elements of the concepts of interest to a specific entity have been updated; and
notifying the entity of the update

13. The method as recited in claim 11, wherein the concepts comprise elements wherein each element has an owner and updates to the element by anyone other then the owner is prevented.

14. The method as recited in claim 1, wherein the concepts are obtained in real time from data acquired from at least one data repository within the enterprise and organized into concepts by the concept directory based on the meta data.

15. The method as recited in claim 1, wherein the concepts are obtained from the concept directory.

16. The method as recited in claim 15, wherein the meta data defines how to combine data from various data repositories within an enterprise into a concept.

17. A computer program product in a computer readable media for use in a data processing system for providing enterprise wide access to and standardization of concepts utilized by diverse groups within an enterprise, the computer program product comprising:
first instructions for creating a centralized concept directory;
second instructions for storing enterprise concepts and metadata in the concept directory; and
third instructions for directing an enterprise software application, a specific concept is needed by the software application, to provide the specific concept to the software application.

18. The computer program product as recited in claim 17, wherein the software application is a web browser retrieving information for a user.

19. The computer program product as recited in claim 17, further comprising:
fourth instructions for implementing enterprise security procedures to prevent unauthorized access to the concepts in the concept directory.

20. The computer program product as recited in claim 17, further comprising:
fourth instructions for assigning a user to a security group which dictates the level of access by the user to content within the concept directory.

21. The computer program product as recited in claim 17, wherein the concepts are structured in a hierarchal fashion organized from a general concept to a specific concept.

22. The computer program product as recited in claim 17, wherein the concepts are structured to contain relationship information relating each element of the concepts to various other related elements, thereby allowing searches on the concept directory to retrieve related elements.

23. The computer program product as recited in claim 17, wherein the concepts comprise at least one of a external companies, commercially available products, generic technology, enterprise portfolio information, industry standards and standards committees, master agreements and corporate licenses, and enterprise organizational structure.

24. The computer program product as recited in claim 23, wherein the external companies comprises at least one of vendors, alliance partners, competitors, and clients.

25. The computer program product as recited in claim 23, wherein the commercially available products comprises at least one of a list of enterprise subject matter experts for a given product, a list of enterprise engagements with a given product, and a list of vendors for various products.

26. The computer program product as recited in claim 23, wherein the generic technology comprises at least one of a list of enterprise subject matter experts for a given technology, a list of enterprise engagements with a given technology, and a list of vendors for various technologies.

27. The computer program product as recited in claim 17, wherein the concepts comprise elements that have several attributes and the attributes comprise at least one of name, description, identification, official point of contact, project, people, organizations, portfolio, relationships, universal resource locators, aliases, creation date, last modified date, and security.

28. The computer program product as recited in claim 17, further comprising:
fourth instructions for determining elements of the concepts of interest to a specific entity have been updated; and
fifth instructions for notifying the entity of the update

29. The computer program product as recited in claim 27, wherein the concepts comprise elements wherein each element has an owner and updates to the element by anyone other then the owner is prevented.

30. The computer program product as recited in claim 17, wherein the concepts are obtained in real time from data acquired from at least one data repository within the enterprise and organized into concepts by the concept directory based on the meta data.

31. The computer program product as recited in claim 17, wherein the concepts are obtained from the concept directory.

32. The computer program product as recited in claim 31, wherein the meta data defines how to combine data from various data repositories within an enterprise into a concept.

33. A system for providing enterprise wide access to and standardization of concepts utilized by diverse groups within an enterprise, the system comprising:
first means for creating a centralized concept directory;
second means for storing enterprise concepts and metadata in the concept directory; and
third means for directing an enterprise software application, a specific concept is needed by the software application, to provide the specific concept to the software application.

34. The system as recited in claim 33, wherein the software application is a web browser retrieving information for a user.

35. The system as recited in claim 33, further comprising:
fourth means for implementing enterprise security procedures to prevent unauthorized access to the concepts in the concept directory.

36. The system as recited in claim 33, further comprising:
fourth means for assigning a user to a security group which dictates the level of access by the user to content within the concept directory.

37. The system as recited in claim 33, wherein the concepts are structured in a hierarchal fashion organized from a general concept to a specific concept.

38. The system as recited in claim 33, wherein the concepts are structured to contain relationship information relating each element of the concepts to various other related elements, thereby allowing searches on the concept directory to retrieve related elements.

39. The system as recited in claim 33, wherein the concepts comprise at least one of a external companies, commercially available products, generic technology, enterprise portfolio information, industry standards and standards committees, master agreements and corporate licenses, and enterprise organizational structure.

40. The system as recited in claim 39, wherein the external companies comprises at least one of vendors, alliance partners, competitors, and clients.

41. The system as recited in claim 39, wherein the commercially available products comprises at least one of a list of enterprise subject matter experts for a given product, a list of enterprise engagements with a given product, and a list of vendors for various products.

42. The system as recited in claim 39, wherein the generic technology comprises at least one of a list of enterprise subject matter experts for a given technology, a list of enterprise engagements with a given technology, and a list of vendors for various technologies.

43. The system as recited in claim 33, wherein the concepts comprise elements that have several attributes and the attributes comprise at least one of name, description, identification, official point of contact, project, people, organizations, portfolio, relationships, universal resource locators, aliases, creation date, last modified date, and security.

44. The system as recited in claim 33, further comprising:
fourth means for determining elements of the concepts of interest to a specific entity have been updated; and
fifth means for notifying the entity of the update

45. The system as recited in claim 43, wherein the concepts comprise elements wherein each element has an owner and updates to the element by anyone other then the owner is prevented.

46. The system as recited in claim 33, wherein the concepts are obtained in real time from data acquired from at least one data repository within the enterprise and organized into concepts by the concept directory based on the meta data.

47. The system as recited in claim 33, wherein the concepts are obtained from the concept directory.

48. The system as recited in claim 47, wherein the meta data defines how to combine data from various data repositories within an enterprise into a concept.

49. A centralized repository of enterprise defined basic enterprise data, the repository comprising:
a directory of enterprise defined basic enterprise data and metadata;
a consumer user interface to provide access to the directory; and
a data manager interface to provide an interface for managers of basic enterprise data to update and add data to the directory; wherein
the directory provides a centralized location for all users and applications utilized within an enterprise to locate and enterprise defined basic enterprise data thereby facilitating the exchange of expertise across the enterprise and standardizing terminology across the enterprise.

50. The centralized repository as recited in claim 49, further comprising:
a search facility for searching for specified data elements within the directory.

51. The centralized repository as recited in claim 49, further comprising:
a reporting utility which monitors data in the directory and notifies a user of updates to data elements of interest to the user.

52. The centralized repository as recited in claim 49, further comprising:
a security utility for enforcing enterprise security policies preventing unauthorized access to and unauthorized modification of enterprise defined basic enterprise data within the directory.

53. The centralized repository as recited in claim 49, wherein the directory is contained within a relational database management system.
